(19) United States
(12) Patent Application Publication
(10) Pub. No.: US 2009/0134091 A1
(43) Pub. Date: May 28, 2009

(54) Method for removing undesirable components from water while containing, cultivating, and harvesting photosynthetic marine microorganisms within water

(75) Inventors: James Stephens, Snohomish, WA (US); Kirk W. Dickinson, Newcastle, WA (US); Kelly Ogilvie, Seattle, WA (US)

Correspondence Address: LAW OFFICES OF MICHAEL DRYJA, 1474 N COOPER RD #105-248, GILBERT, AZ, 85233, US

(73) Assignee: GREEN VISION ENERGY CORPORATION, Seattle, WA (US)

(21) Appl. No.: 11/944,611

(22) Filed: Nov. 24, 2007

(51) Int. Cl. C02F 3/32; C02F 3/00

(52) U.S. Cl. 210/602; 210/610

(57) ABSTRACT

Undesirable components are removed from water while photosynthetic marine microorganisms within the water are contained, cultivated, and harvested. An apparatus is placed within the water. The apparatus has a mesh lining adapted to permit the water, the undesirable components, and nutrients to enter through the mesh lining while at least substantially preventing the marine microorganisms that are being cultivated from escaping through the mesh lining. The marine microorganisms are cultivated, including by adding the nutrients to the water. The nutrients at least accelerate growth of the marine microorganisms, where the marine microorganisms feed off the undesirable components and the nutrients. The marine microorganisms that have been cultivated are then harvested, which includes removing the marine microorganisms from the water.

### RELATED PATENT APPLICATIONS

The present patent application is related to the cofiled, copending, and coassigned patent application entitled “apparatus for containing, cultivating, and harvesting photosynthetic marine microorganisms within water,” the contents of which are hereby incorporated in their entirety by reference.

### BACKGROUND

Photosynthetic marine microorganisms include micro- and macro-sized algae, among other types of such microorganisms. While photosynthetic marine microorganisms grow naturally, cultivating them purposefully in large numbers has become attractive due to the increasing value of these microorganisms. For example, algae in particular has become for bio-fuel production, energy generation, agricultural material production, and carbon sequestration purposes, among other purposes. However efficiently and inexpensively intentionally growing photosynthetic marine microorganisms like algae has proven relatively difficult.

Furthermore, bodies of water, including both saltwater and freshwater bodies of water, are at least occasionally contaminated with undesirable components, such as nitrogen and phosphorus. Such undesirable components may be introduced to bodies of water due to the discharge of residential and commercial wastewater, for instance. Removing these undesirable components from the water is a relatively expensive process, however. For example, typically governmental environmental departments are charged with remediating water of such undesirable components, but these departments often do not have sufficient funding to completely eliminate the problem.

### SUMMARY

The present invention relates to removing undesirable components are removed from water while containing, cultivating, and harvesting photosynthetic marine microorganisms within the water. An apparatus is placed within the water. The apparatus has a mesh lining adapted to permit the water, the undesirable components, and nutrients to enter through the mesh lining while at least substantially preventing the marine microorganisms that are being cultivated from escaping through the mesh lining. The marine microorganisms are cultivated, including by adding the nutrients to the water. The nutrients at least accelerate growth of the marine microorganisms, where the marine microorganisms feed off the undesirable components and the nutrients. The marine microorganisms that have been cultivated are then harvested, which includes removing the marine microorganisms from the water.

Embodiments of the invention provide for advantages over the prior art. The marine microorganisms that are grown may be algae, which naturally feed off undesirable nitrogen and phosphorous that may already be present within the water. As such, the water is remediated of these undesirable components. Furthermore, the algae itself is contained, cultivated and harvested for valuable purposes. Such purposes include bio-fuel production, energy generation, agricultural material production, and carbon sequestration, among other purposes. Thus, rather than being a net cost, remediating water of undesirable nitrogen and phosphorous becomes a beneficial side effect of intentionally growing algae. Still other aspects, advantages, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a top view of an apparatus for containing, cultivating, and harvesting photosynthetic marine microorganisms within water, according to an embodiment of the invention.

FIG. 2 is a diagram of a front view of an apparatus of FIG. 1, according to an embodiment of the invention.

FIG. 3 is a flowchart of a method for removing undesirable components from water while containing, cultivating, and harvesting photosynthetic marine microorganisms within the water, according to an embodiment of the invention.

FIGS. 4 and 5 are diagrams depicting representative performance of some of the parts of the method of FIG. 3, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

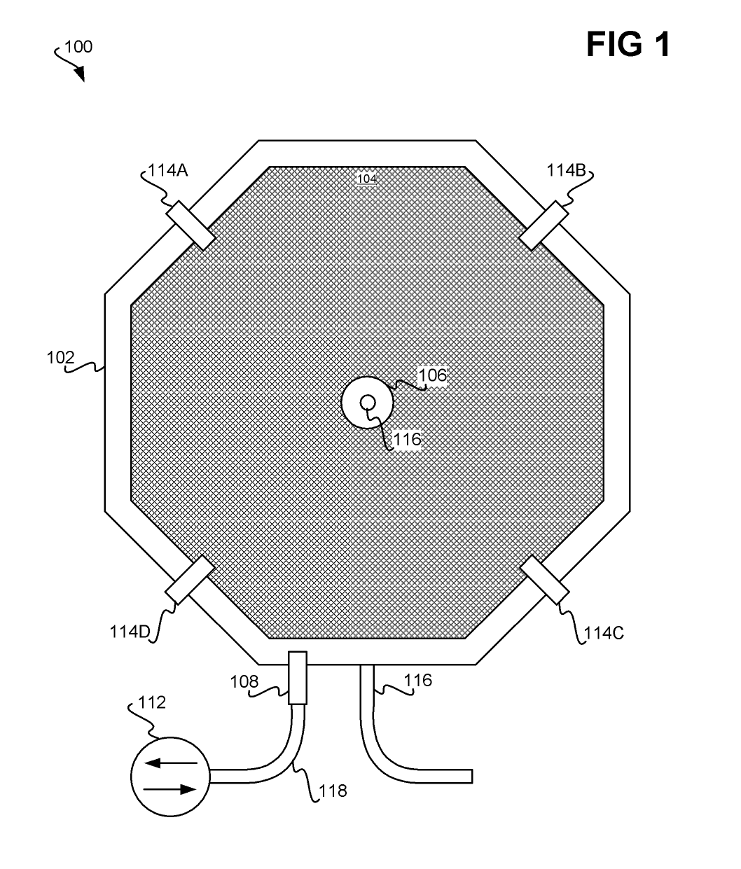

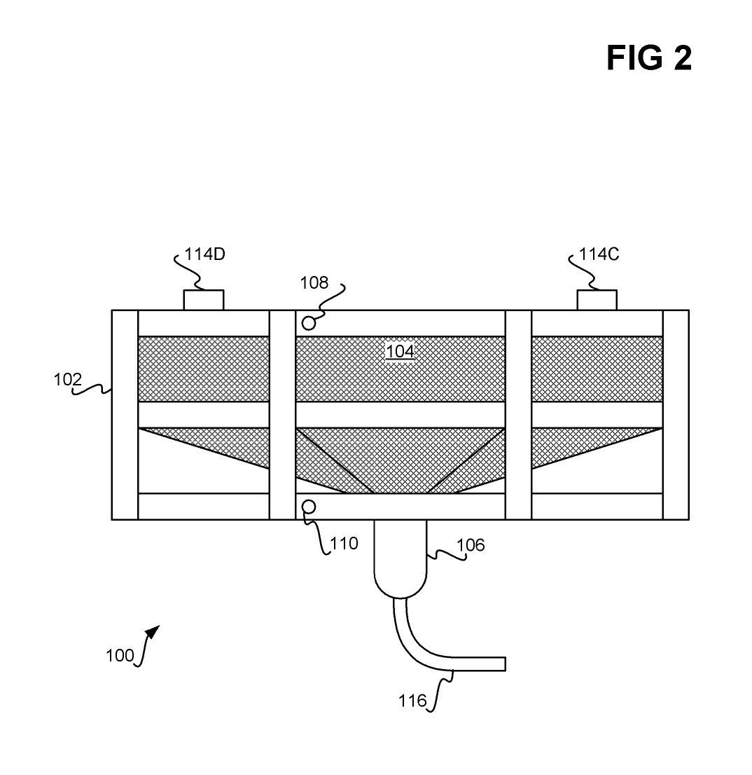

FIGS. 1 and 2 show a top view and a front view, respectively, of an apparatus 100 for containing, cultivating, and harvesting photosynthetic marine microorganisms, such as micro- and macro-sized algae, within water, according to an embodiment of the invention. The apparatus 100 is described in more detail in the cofiled, copending, and coassigned patent application entitled “apparatus for containing, cultivating, and harvesting photosynthetic marine microorganisms within water,” which has already been incorporated by reference. However, while embodiments of the invention are described and can be performed in relation to the apparatus 100, other embodiments of the invention are amenable to implementation and performance in relation to other apparatuses.

The apparatus 100 includes a self-supporting buoyant frame 102. The frame 102 is self-supporting in that it does not require any additional components or members to support it. The frame 102 is buoyant in that it can float in water. The frame 102 may have an octagonal shape, as is specifically depicted in FIGS. 1 and 2, or it may have a different shape, such as a circular, square, rectangular, oval, and/or prismatic shape, among other types of shapes.

The frame 102 is fabricated from a durable material such that the frame 102 has sufficient structural strength and is also buoyant. For example, the frame 102 may be fabricated from hollowing tubing. The hollow tubing has an interior space that is receptive to water and gas, such as air, in different combinations. In one embodiment, the frame 102 may be free-floating.

Additionally, or alternatively, the apparatus 100 may include a number of anchoring points 114A, 114B, 114C, and 114D, collectively referred to as the anchoring points 114. While there are four anchoring points 114 in FIGS. 1 and 2, there may be more or less of such anchoring points 114 in other embodiments. The anchoring points 114 permit the frame 102 to be floatatively anchored in place, to be moved within the water, as well as to be lifted from the water, such as by employing a crane.

The apparatus 100 includes a mesh lining 104 within the interior of the frame 102. The mesh lining 104 thus defines a space within the apparatus 100. The mesh lining 104 is adapted to permit water and the nutrients needed for the marine microorganisms to grow to enter the space through the mesh lining 104, while at least substantially preventing the marine microorganisms from escaping the space within which they are being cultivated through the mesh lining 104. The mesh lining 104 may be fabricated from metal and/or fabric in one embodiment.

The mesh lining 104 specifically is or has a micron-sized mesh in one embodiment. Through experimentation, the inventors have determined that a mesh of one to forty microns in size is preferred to permit nutrients to enter through the mesh lining 104 while at least substantially preventing the marine microorganisms from escaping through the mesh lining 104. A mesh of one to forty microns in size means that the openings defined by the mesh are each one to forty microns in size.

The apparatus 100 includes a funnel 106, such as a cone, attached to a corresponding hole at the bottom of the mesh lining 104, substantially in the center of the mesh lining 104 in one embodiment. The funnel 106 is adapted to permit the marine microorganisms that have been cultivated to be harvested. In particular, the funnel 106 has a first opening at which the funnel 106 is attached to the corresponding hole of the mesh lining 104, and a second opening at which a hose 116 is removably connected. The first opening may be larger in size than the second opening.

When the hose 116 is not attached to the funnel 106, the opening in question is capped or otherwise closed. When the hose 116 is attached to the funnel 106, a pump or another piece of equipment can be employed to suction the marine microorganisms that have been cultivated from the apparatus 100 for further processing. Removing the marine microorganisms from the apparatus 100 is thus what is meant by harvesting in this respect.

The apparatus 100 includes a buoyancy leveling subsystem that includes a top valve 108, a bottom valve 110, and/or a compressor 112 in one embodiment. The buoyancy leveling subsystem is generally adapted to control the extent to which the frame 102 is submerged within the water in which the frame 102 has been placed. For instance, while the marine microorganisms are being cultivated, the buoyancy leveling subsystem is controlled so that the majority of the frame 102 is submerged. By comparison, when the marine microorganisms are ready to be harvested, the buoyancy leveling subsystem is controlled so that the majority of the frame 102 is not submerged.

Both the valves 108 and 110 are disposed within the hollow tubing of the frame 102 such that they are fluidically connected with the interior space within the hollow tubing. The top valve 108 is located at or near the top of the frame 102, while the bottom valve 110 is located at or near the bottom of the frame 102. In one embodiment, the bottom valve 110 may specifically be simply one or more holes within the frame 102, where these holes remain open substantially all the time, externally exposing the interior space of the hollow tubing.

The top valve 108 in one embodiment is positioned on the frame 102 so that the valve 108 is never submerged underwater, regardless of the extent to which the frame 102 is submerged. Likewise, the bottom valve 110 in one embodiment is positioned on the frame 102 so that the valve 110 is always submerged underwater, regardless of the extent to which the frame 102 is submerged. In the embodiment where the bottom valve 110 always externally exposes the interior space of the hollow tubing of the frame 102, this means that the hollow tubing is always externally exposed to water while the apparatus 100 is being employed.

The top valve 108 has a number of mutually exclusive states in which it is adapted to operate. The top valve 108 is operated in different of these states to control the extent to which the frame 102 is submerged within the water. In an open state, the top valve 108 is opened to externally expose the interior space of the hollow tubing of the frame 102. In this state of the top valve 108, the level of the water within the hollow tubing of the frame 102 increases, and the extent to which the frame 102 is submerged within the water increases. This is because water enters the bottom valve 110, naturally displacing the gas, such as air, that had been in the hollow tubing and which had previously maintained the frame 102 at a higher level within the water.

In a closed state, the top valve 108 is closed to at least substantially not externally expose the interior space of the hollow tubing of the frame 102. In this state of the top valve 108, the level of the water within the hollow tubing of the frame 102 remains at least substantially constant, and the extent to which the frame 102 is submerged within the water remains at least substantially constant. This is because the water and the gas, such as air, within the hollow tubing remains at a substantially constant combination. The gas cannot escape from the top valve 110, so no water enters the bottom valve 110, even though it is open, because the water has nothing to displace.

In a gas-transfer state, the top valve 108 is fluidically and removably connected to the compressor 112 via a hose 118. The compressor 112 forcibly pumps gas, such as air, into the hollow tubing of the frame 102 through the top valve 108. In this state of the top valve 108, the level of the water within the hollow tubing of the frame 102 decreases, and the extent to which the frame 102 is submerged within the water decreases. This is because the gas pushes, or displaces, at least some of water from the hollow tubing through the bottom valve 110.

Therefore, when marine microorganisms are to be cultivated within the apparatus 100, the top valve 108 may be opened to enter the open state, so that the frame 102 sinks to a lower level within the water. Once the frame 102 has reached the desired (lower) submersion level, the top valve 108 is closed to enter the closed state, in which the frame 102 remains at this submersion level within the water. When the microorganisms are ready to be harvested, the top valve 108 is opened and the compressor 112 fluidically connected thereto via the hose 118 so that the valve 108 enters the gas-transfer state. The compressor 112 is turned on so that the frame 102 rises to a higher level within the water. Once the frame 102 has reached the desired (higher) submersion level, the top valve 108 is again closed to enter the closed state, and the frame 102 remains at this submersion level within the water so that the microorganisms can be harvested.

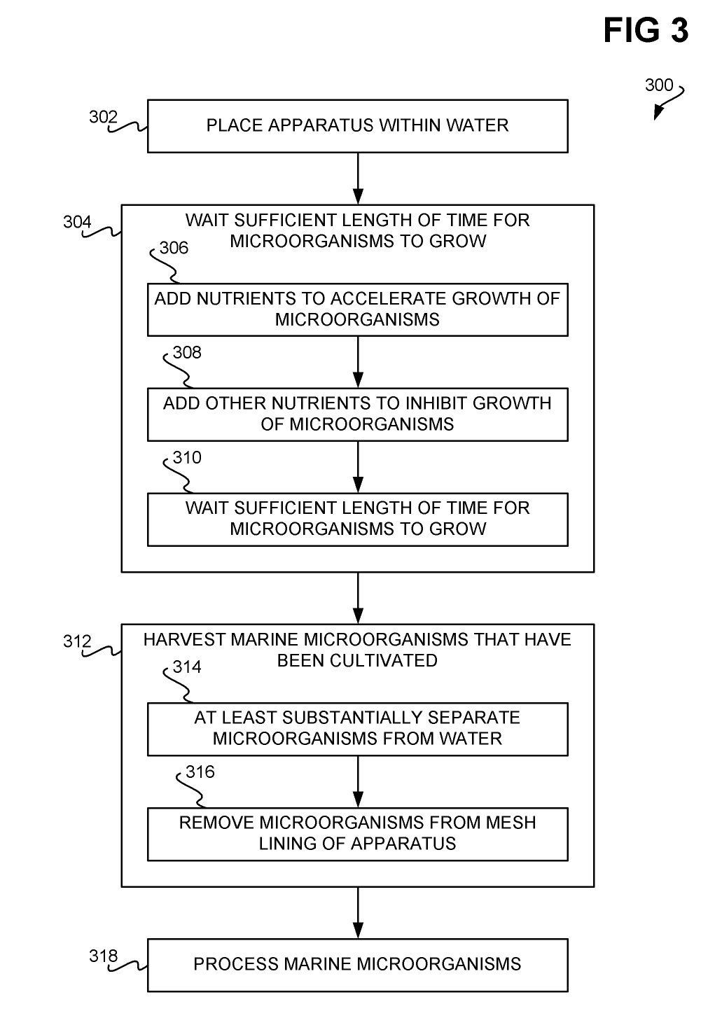

FIG. 3 shows a method 300 for removing undesirable components from water while containing, cultivating, and harvesting photosynthetic marine microorganisms within the water, according to an embodiment of the invention. An apparatus is placed within a body of water (302), such as a body of freshwater or a body of seawater. The body of water may already have undesirable components like nitrogen and phosphorous in various concentrations. The apparatus placed in the water may be the apparatus 100 that has been described, or another type of apparatus. For instance, such an apparatus may include a mesh lining, such as the mesh lining 104 that has been described. The mesh lining of the apparatus permits the water, the undesirable components, and nutrients to enter therethrough while at least substantially preventing the marine microorganisms, such as algae, which are being cultivated from escaping therethrough.

The marine microorganisms are then cultivated within the apparatus (304). Cultivation of the marine microorganisms can be achieved by performing one or more of the following in any order. First, nutrients may be added to accelerate the growth of the marine microorganisms (306). For example, the marine microorganisms may feed off the undesirable nitrogen and phosphorous already in the water, such that the water is remediated of these undesirable components. However, there may not be sufficient nitrogen and phosphorous already in the water to grow the marine microorganisms so that the desired quantity and/or the desired concentration of the microorganisms is yielded, and/or that the microorganisms are grown at the desired rate. Therefore, additional nitrogen and/or phosphorous, as well as other nutrients, may be added to the water in sufficient quantities and/or at sufficient rates to increase the growth of the marine microorganisms. The marine microorganisms thus feed off the undesirable components within the water, as well as off the nutrients added to the water.

Second, other nutrients may be added to inhibit the growth of the marine microorganisms (308). As before, the marine microorganisms may feed off the undesirable nitrogen and phosphorous already in the water, such that the water is remediated of these undesirable components. However, there may be too much nitrogen and phosphorous already in the water, such that the marine microorganisms may grow more quickly than desired (e.g., more quickly than can be harvested). Therefore, limiting nutrients, such as metals, may be added to the water in sufficient quantities and/or at sufficient rates to decrease the growth of the marine microorganisms. As such, the microorganisms are again grown such that the desired quantity and/or the desired concentration of the microorganisms is yielded, and/or such that the microorganisms are grown at the desired rate.

Third, cultivating the marine microorganisms can include waiting for a sufficient length of time so that the desired quantity and/or the desired concentration of the microorganisms are grown (310). It is further noted that the nutrients added to the water in part 306 and/or part 308 are added in a controlled manner. This ensures that the growth of the marine microorganisms at least substantially occurs only within the apparatus that has been placed in the water. For example, the nutrients may be added to the water surrounded by the mesh lining of the apparatus, or otherwise added to the water surrounded by the apparatus.

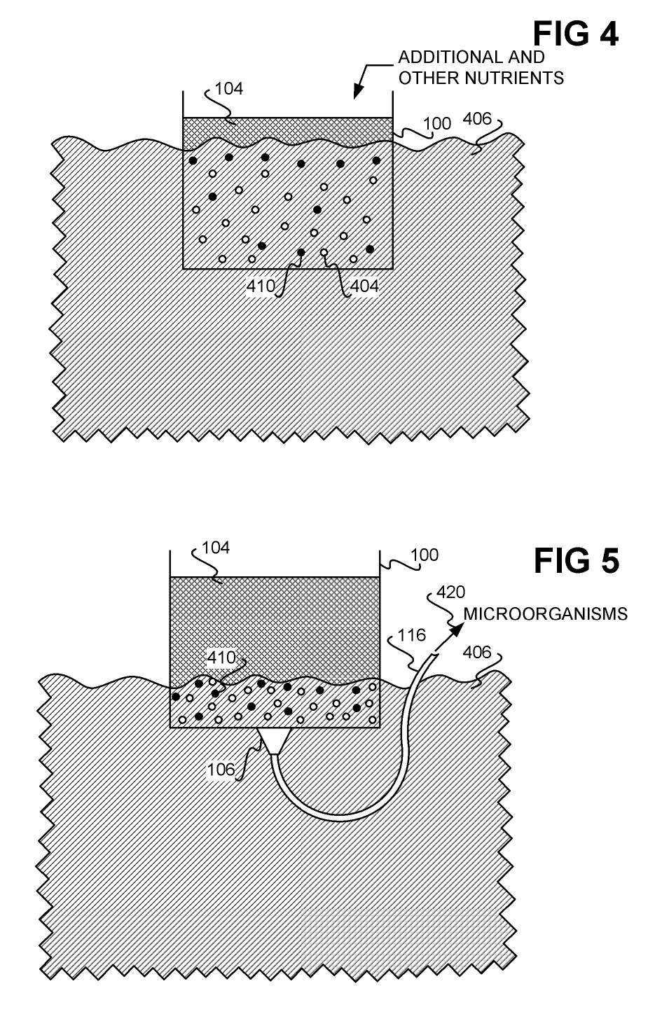

FIG. 4 shows representative performance of parts 302 and 304 of the method 300, according to an embodiment of the invention. The apparatus 100 has been placed in the water 406, such that the majority of the mesh lining 104 is submerged under the water 406. For illustrative convenience and clarity, just the mesh lining 104 is depicted in FIG. 4; no other components of the apparatus 100 are particularly shown in FIG. 4. The water 406 includes undesired components already present within the water 406. These undesired components, such as already existing nitrogen and algae, are represented in FIG. 4 as hollow circles, such as the hollow circle 404.

Thereafter, nutrients are added to the water, as indicated by the arrow 408. The nutrients may include nutrients to accelerate marine microorganism growth, such as additional phosphorous or nitrogen, as well as limiting nutrients to limit marine microorganism growth, such as metals. The end result is that after waiting for a sufficient length of time, a desired quantity and/or a desired concentration of marine microorganisms are grown. These marine microorganisms such as algae, are represented in FIG. 4 as solid circles, such as the solid circle 410.

It is noted that the nutrients are added to the water in a controlled manner, as is also indicated by the arrow 408. For instance, a controlled quantity of the nutrients is added at a controlled rate. Furthermore, the nutrients may be added to the water 406 surrounded by the apparatus 100, as is specifically depicted in FIG. 4.

Referring back to FIG. 3, once the marine microorganisms have been cultivated within the apparatus, the microorganisms are harvested (312). Harvesting the marine microorganisms can be achieved by performing the following. First, the marine microorganisms are at least substantially separated from the water (314). This results in the creation of a dense slurry of the marine microorganisms within the water. The slurry includes some water, but not as much water as before substantial separation of the marine microorganisms from the water.

At least substantially separating the marine microorganisms from the water can include at least partially raising the apparatus from the water. In one embodiment, the apparatus may be completely removed from the water. In another embodiment, the apparatus may just be raised within the water, and still remain within the water. As such, a lesser portion of the apparatus is submerged within the water after the apparatus has been raised as compared to before the apparatus has been raised.

Once the marine microorganisms have been at least substantially separated from the water, the microorganisms are removed from the mesh lining of the apparatus (316). Such removal can include removing the slurry of which the marine microorganisms are a part. For instance, the marine microorganisms may be pumped and/or suctioned from the mesh lining of the apparatus through a funnel attached to the bottom of the mesh lining.

FIG. 5 shows representative performance of part 312 of the method 300, according to an embodiment of the invention. The apparatus 100 is depicted as including the mesh lining 104 and the funnel 106; other components of the apparatus 100 are not depicted in FIG. 5 for illustrative convenience and clarity. The apparatus 100 has been raised within the water 406 so that just a small portion of the mesh lining 104 remains submerged within the water 406. As a result, all the marine microorganisms that have been cultivated are disposed at the bottom of the mesh lining 104, within a slurry. The marine microorganisms are again depicted as solid circles, such as the solid circle 410.

To remove the marine microorganisms from the mesh lining 104 (i.e., to remove the slurry containing these microorganisms from the mesh lining 104), the microorganisms are pumped or suctioned through the funnel 106 attached to the bottom of the mesh lining 104. The funnel 106 is attached to one end of the hose 116, and the marine microorganisms are retrieved or released at the other end of the hose 116, as indicated by the arrow 420. In this way, marine microorganisms, such as algae, that have been cultivated can be harvested.

Referring back to FIG. 3, once the marine microorganisms have been cultivated and harvested, the microorganisms can be processed as desired (318). For instance, algae in particular may be processed to produce bio-fuel, generate energy, produce agricultural material, and/or sequester carbon. It is noted that the carbon sequestration process is actually completed once the marine microorganisms have been cultivated; the microorganisms may be subsequently harvested just to remove these microorganisms as a waste produce from the water.

The method 300 thus results in the production of a useful material—marine microorganisms such as algae. Within this process, undesired components, such as nitrogen and/or phosphorous, are also remediated from the water. Thus, while in the prior art such remediation can be considered an environmental cleanup cost, embodiments of the invention turn this cost into a net benefit, by producing marine microorganisms that can then be harvested and processed for other desirable activities.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A method for removing one or more undesirable components from water while containing, cultivating, and harvesting photosynthetic marine microorganisms within the water, comprising:
placing an apparatus within the water, the apparatus having a mesh lining adapted to permit the water, the undesirable components, and one or more nutrients to enter through the mesh lining while at least substantially preventing the marine microorganisms that are being cultivated from escaping through the mesh lining;
cultivating the marine microorganisms within the apparatus, including adding the nutrients to the water, the nutrients at least accelerating growth of the marine microorganisms, the marine microorganisms feeding off the undesirable components and the nutrients; and,
harvesting the marine microorganisms that have been cultivated within the apparatus, including removing the marine microorganisms from the water.

2. The method of claim 1, wherein cultivating the marine microorganisms within the apparatus comprises waiting for a sufficient length of time for a desired quantity and/or concentration of the marine microorganisms to grow within the water.

3. The method of claim 1, wherein cultivating the marine microorganisms within the apparatus comprises adding the nutrients to the water in quantities and/or at rates to increase growth of the marine microorganisms, such that a desired quantity and/or concentration of the marine microorganisms is yielded and/or the growth of the marine microorganisms occurs at a desired rate.

4. The method of claim 1, wherein cultivating the marine microorganisms within the apparatus comprises adding one or more limiting nutrients to the water in quantities and/or at rates to decrease growth of the marine microorganisms, such that a desired quantity and/or concentration of the marine microorganisms is yielded and/or the growth of the marine microorganisms occurs at a desired rate.

5. The method of claim 4, wherein the limiting nutrients comprise metals.

6. The method of claim 1, wherein adding the nutrients to the water comprises adding the nutrients to the water in a controlled manner such that growth of the marine microorganisms at least substantially occurs only within the apparatus.

7. The method of claim 1, wherein harvesting the marine microorganisms that have been cultivated within the apparatus comprises at least partially raising the apparatus from the water to at least substantially separate the marine microorganisms from the water.

8. The method of claim 7, wherein substantially separating the marine microorganisms from the water comprises creating a dense slurry of the marine microorganisms within the water.

9. The method of claim 7, wherein at least partially raising the apparatus from the water comprises removing the apparatus from the water.

10. The method of claim 7, wherein at least partially raising the apparatus from the water comprises raising the apparatus within the water such that a lesser portion of the apparatus is submerged within the water after the apparatus has been raised.

11. The method of claim 7, wherein harvesting the marine microorganisms that have been cultivated within the apparatus further comprises removing the marine microorganisms from the mesh lining of the apparatus after the marine microorganisms have been at least substantially separated from the water.

12. The method of claim 11, wherein removing the marine microorganisms from the mesh lining of the apparatus comprises one or more of pumping and suctioning the marine microorganisms from the mesh lining of the apparatus through a funnel attached to a bottom of the mesh lining of the apparatus.

13. The method of claim 1, further comprising processing the marine microorganisms that have been cultivated and subsequently harvested.

14. The method of claim 13, wherein the marine microorganisms are processed to one or more of: produce bio-fuel; generate energy; produce agricultural material; and, sequester carbon.

15. The method of claim 1, wherein the marine microorganisms comprise macro-sized and micro-sized marine algae.

16. The method of claim 1, wherein the undesirable components comprise one or more of phosphorous and nitrogen already within the water.

17. The method of claim 16, wherein the nutrients comprise one or more of additional phosphorous not already within the water, and additional nitrogen not already within the water.

18. A method for removing one or more undesirable components from water while containing, cultivating, and harvesting photosynthetic marine microorganisms within the water, comprising:
placing an apparatus within the water, the apparatus having a mesh lining adapted to permit the water, the undesirable components, and one or more nutrients to enter through the mesh lining while at least substantially preventing the marine microorganisms that are being cultivated from escaping through the mesh lining;
adding the nutrients to the water in quantities and/or at rates to increase growth of the marine microorganisms, such that a desired quantity and/or concentration of the marine microorganisms is yielded and/or the growth of the marine microorganisms occurs at a desired rate;
waiting for a sufficient length of time for the desired quantity and/or concentration of the marine microorganisms to grow within the water;
at least substantially separating the marine microorganisms from the water after the marine microorganisms have grown within the water; and,
removing the marine microorganisms from the mesh lining of the apparatus after the marine microorganisms have been at least substantially separated from the water.

19. The method of claim 18, further comprising processing the marine microorganisms that have grown and that have been subsequently at least substantially separated from the water and removed from the mesh lining of the apparatus.

20. The method of claim 18, wherein the marine microorganisms comprise macro-sized and micro-sized marine algae, the undesirable components comprise one or more of phosphorous and nitrogen already within the water, and the nutrients comprise one or more of additional phosphorous not already within the water, and additional nitrogen not already within the water.
